(19) United States
(12) Patent Application Publication
(10) Pub. No.: US 2026/0228101 A1
(43) Pub. Date: Aug. 6, 2026

(54) PREDICTIVE DATASET REDUCTION FOR OPTIMIZING COMPUTING TASKS IN A NETWORK AND COMPUTE FABRIC

(71) Applicant: Cisco Technology, Inc., San Jose, CA (US)

(72) Inventors: Faisal Abdel Kader Azizullah, Plano, TX (US); Jason Adam Kuhne, Hopkinton, MA (US); Steven Michael Holl, Sarasota, FL (US)

(73) Assignee: Cisco Technology, Inc., San Jose, CA (US)

(21) Appl. No.: 19/042,133

(22) Filed: Jan. 31, 2025

(51) Int. Cl. G06F 11/34; G06F 9/48

(52) U.S. Cl. CPC G06F 11/3409; G06F 9/4881; G06F 2209/486

(57) ABSTRACT

In one implementation, a device obtains performance metrics for a network or compute fabric. The device makes, based on the performance metrics, a prediction that using a full dataset in network or compute fabric to perform a first computing task would lead to contention in the network or compute fabric with respect to a second computing task. The device forms, based on the prediction, a reduced dataset that the device predicts will avoid the contention with respect to the second computing task. The device schedules performance of the first computing task in the network or compute fabric using the reduced dataset.

### TECHNICAL FIELD

The present disclosure relates generally to network compute fabrics and, more particularly to predictive dataset reduction for optimizing computing tasks in a network and compute fabric.

### BACKGROUND

In modern artificial intelligence (AI) and high-performance computing (HPC), fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Common network implementations for connecting front-end CPU-based networks and backend GPU-based HPC networks to facilitate data transfer and high-performance computing tasks include High-Speed Ethernet, InfiniBand, NVLink, Peripheral Component Interconnect Express (PCIe), and Fibre Channel (FC), among others. When it comes to AI workloads, a front-end network scheduler is typically used to schedule and orchestrate AI-related workloads ranging from model training to inferencing and data processing. This scheduling often entails coordinating various resources and services, managing job queues, and ensuring that the right data and computational resources are available.

However, in current deployments, the front-end network schedules model training without awareness of the backend, HPC network's state, bandwidth, latency, and other characteristics, leading to inefficiencies in both overall model training as well as the potential to further exacerbate backend network contention.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a generative model;

FIG. 4 illustrates an example architecture for an artificial intelligence (AI) agent;

FIG. 5 illustrates an example network or compute fabric for performing AI model training and high-performance computing (HPC) tasks;

FIG. 6 illustrates an example decision tree for scheduling the training of two AI models;

FIGS. 7A-7D illustrate an example of predictive dataset reduction for scheduling computing tasks in a network or compute fabric;

FIG. 8 illustrates an example of performing model validation after training an AI model; and

FIG. 9 illustrates an example simplified procedure for predictive dataset reduction for scheduling computing tasks in a network or compute fabric, in accordance with one or more implementations described herein.

### DESCRIPTION OF EXAMPLE IMPLEMENTATIONS

### Overview

According to one or more implementations of the disclosure, a device obtains performance metrics for a network or compute fabric. The device makes, based on the performance metrics, a prediction that using a full dataset in network or compute fabric to perform a first computing task would lead to contention in the network or compute fabric with respect to a second computing task. The device forms, based on the prediction, a reduced dataset based on the full dataset that the device predicts will avoid the contention with respect to the second computing task. The device schedules performance of the first computing task in the network or compute fabric using the reduced dataset.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

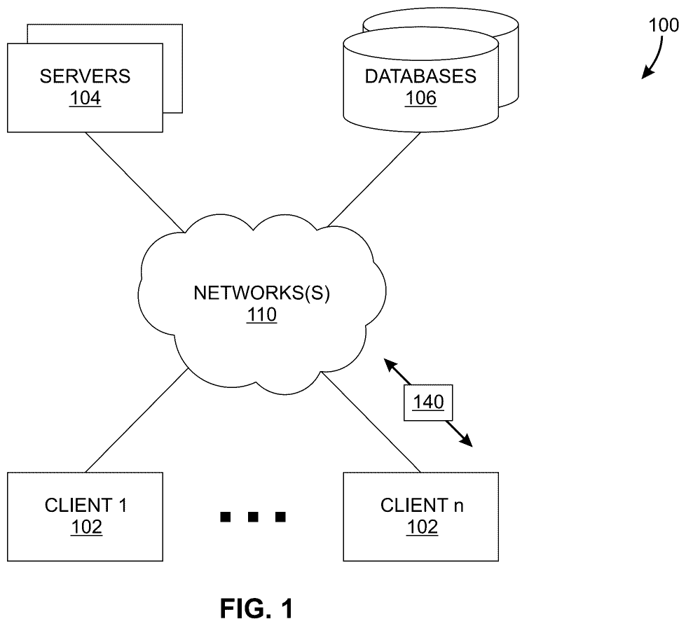

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

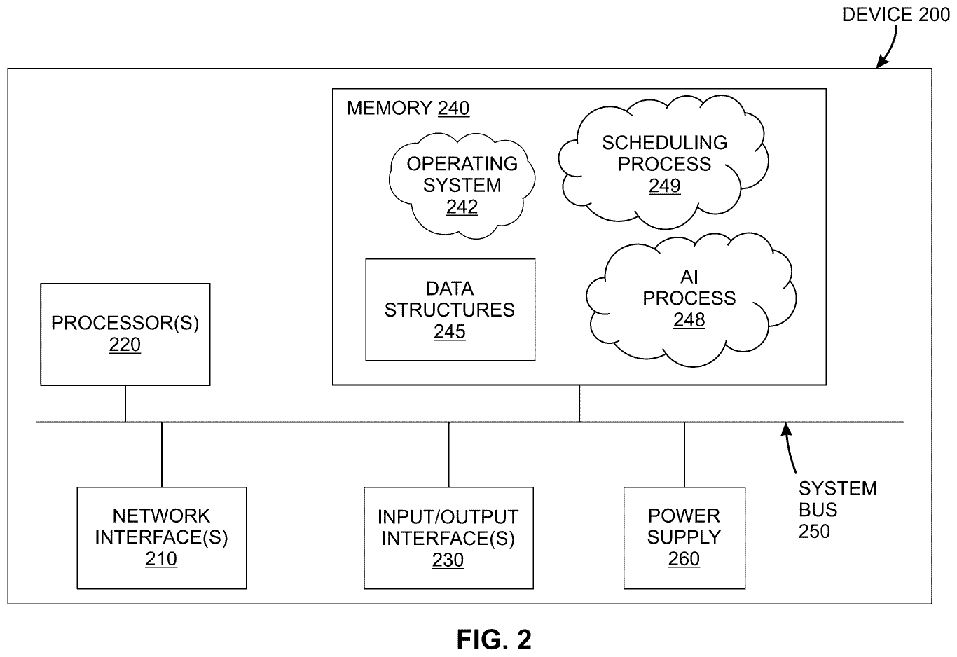

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248 and/or a scheduling process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 and/or scheduling process 249 may include computer executable instructions that, when executed by processor 220, cause device 200 to perform the techniques described herein. To do so, in some implementations, AI process 248 and/or scheduling process 249 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*c+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 and/or scheduling process 249 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that AI process 248 and/or scheduling process 249 could use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 and/or scheduling process 249 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

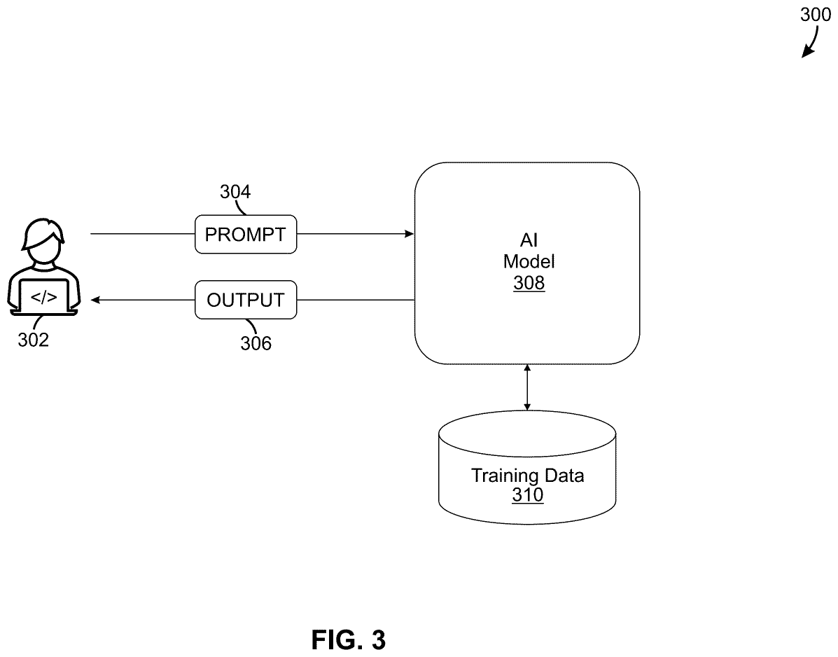

FIG. 3 illustrates an example 300 for interfacing with a generative model, in various implementations. In example 300, a user 302 may send a prompt 304 (e.g., a query, a query augmented with additional data, documents, and/or images, etc.) to an AI model 308. The AI model 308 may be configured to process a prompt 304 to generate an output 306 to satisfy the prompt 304.

AI model 308 may be a model configured to apply its trained algorithms to generate a response (e.g., output 306) based on the prompt 304 provided. More specifically, AI model 308 may be trained on a training dataset 310 and, once trained, be deployed for inference. For instance, in some cases, AI model 308 may take the form of a large language model (LLM) or other foundation model, diffusion-based model, combinations thereof, or the like.

The output 306 may be the result produced by AI model 308 (e.g., by the application of AI model 308 to the prompt 304). This output can vary depending on the model's configuration and the task at hand. For example, the output 306 may include one or more of a generated and/or synthesized image, a text response, a classification and/or prediction, etc.

As would be appreciated, AI agents are also capable of interacting with generative models, such as AI model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

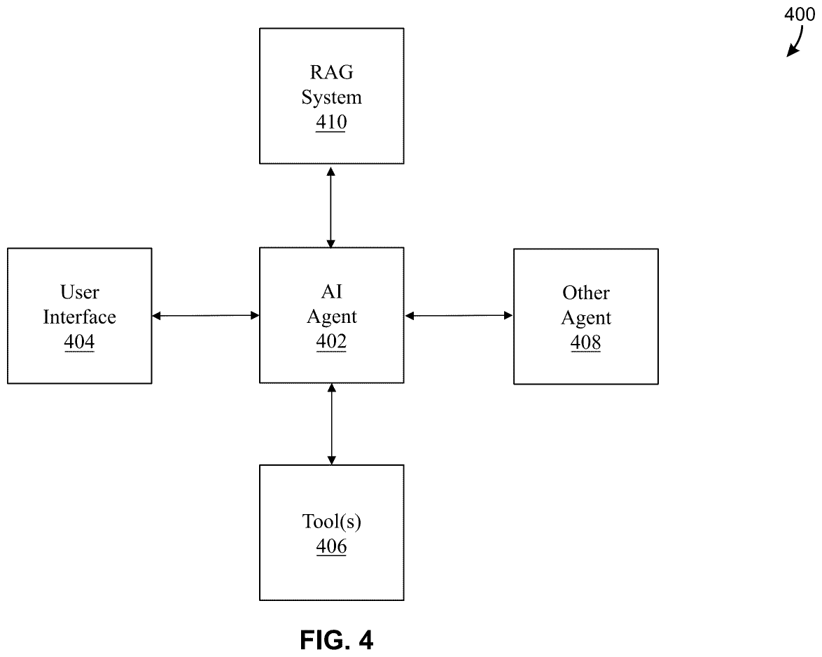

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, LLMs and other modern AI models are capable of performing a wide variety of tasks. In addition, agentic systems may leverage such models to perform an even larger set of tasks.

However, training an AI model and performing other high-performance computing (HPC) tasks is not straightforward, as network or compute fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Common network implementations for connecting front-end CPU-based networks and backend GPU-based HPC networks to facilitate data transfer and high-performance computing tasks include High-Speed Ethernet, InfiniBand, NVLink, Peripheral Component Interconnect Express (PCIe), and Fibre Channel (FC), among others. When it comes to AI workloads, a front-end network scheduler is typically used to schedule and orchestrate AI-related workloads ranging from model training to inferencing and data processing. This scheduling often entails coordinating various resources and services, managing job queues, and ensuring that the right data and computational resources are available.

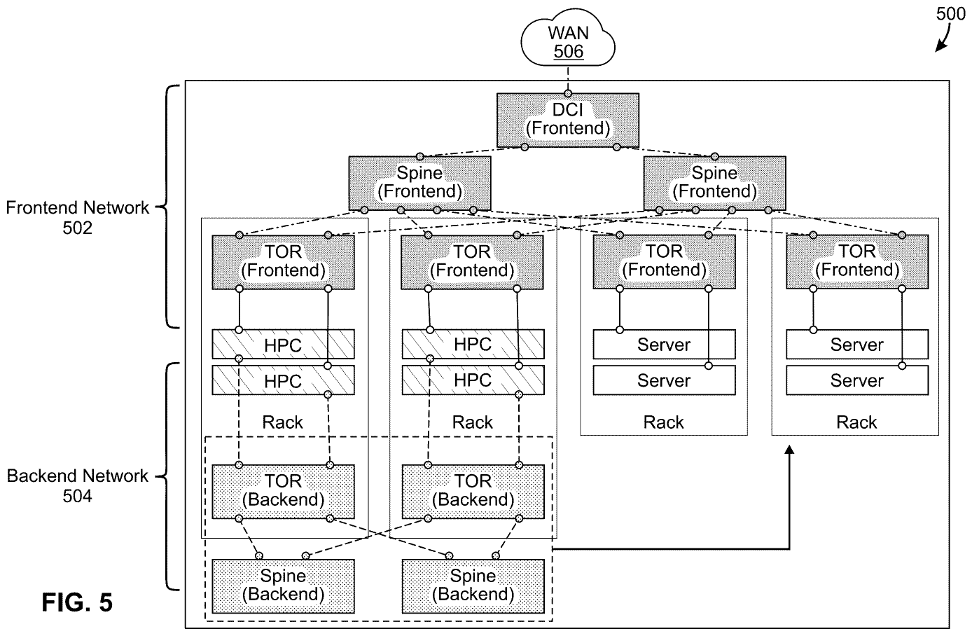

By way of example, FIG. 5 illustrates an example network or compute fabric 500 for performing AI model training and HPC tasks, according to various implementations. As shown, network or compute fabric 500 may include a frontend network 502 and a backend network 504. Network or compute fabric 500 may also be connected to a WAN 506, allowing for remote access.

For instance, frontend network 502 may include various components such as a data center interconnect (DCI), any number of frontend spines, a plurality of top-of-rack (TOR) switches, etc. Likewise, backend network 504 may include HPC clusters, servers, its own backend TOR switches, etc. on the racks, as well as its own backend spines. As would be appreciated, the specific configuration and components of frontend network 502 and backend network 504 may differ as desired.

However, in current deployments, the frontend network, such as frontend network 502, schedules model training and other computing tasks without awareness of the state, bandwidth, latency, and other characteristics of the backend network, such as backend network 504, leading to inefficiencies in both overall model training as well as the potential to further exacerbate backend network contention.

### Predictive Dataset Reduction for Scheduling Computing Tasks in a Network or Compute fabric

The techniques herein use predictive analytics based on the historical performance of a backend GPU/HPC cluster in a network or compute fabric to anticipate contention conditions and, in turn, reduce the dataset for a given computational task to avoid this predicted contention. For instance, in the case of AI model training, the techniques herein may predict cases of oversubscription of model training demand and intelligently reduce the training dataset so that a model can still be trained in a timely fashion without subjecting imposing a contention condition on other models that may be scheduled for training and/or have an ‘available by’ service level agreement as a deployment deadline (e.g., a point in time by which the model needs to be available for use).

Illustratively, the techniques described herein may be performed by hardware, software, and/or firmware, such through execution of scheduling process 249, which may include computer executable instructions executed by the processor 220 (or independent processor of interfaces 210) to perform functions relating to the techniques described herein, e.g., in conjunction with AI process 248.

Specifically, according to various implementations, a device obtains performance metrics for a network or compute fabric. The device makes, based on the performance metrics, a prediction that using a full dataset in network or compute fabric to perform a first computing task would lead to contention in the network or compute fabric with respect to a second computing task. The device forms, based on the prediction, a reduced dataset based on the full dataset that the device predicts will avoid the contention with respect to the second computing task. The device schedules performance of the first computing task in the network or compute fabric using the reduced dataset.

Operationally, in various implementations, the techniques herein provide the following functionalities with respect to a network or compute fabric:
Using telemetry and observability data from the backend network to predict the computational demands of a cluster, based on past demand patterns and training performance, to forecast future demand and times of contention. The frontend network scheduler can then use these predictions when scheduling computing tasks in the fabric, such as model training.
Intelligently leveraging data reduction (e.g. summarization, quantitative

aggregation, image/audio down sampling, pruning, etc.) when needed to reduce the time needed to perform a computational task, such as model training.
Advertising and posting training data reduction sets, for other training needs

to also leverage on demand, when training data sets may be shared across different models.

By way of example, consider the case in which the network or compute fabric (e.g., network or compute fabric 500) retrains a large AI model, model A, on a weekly basis, based on newly fetched information. The model takes four days to train and runs weekly from Tuesday to Friday. On Fridays, the owner of the model then deploys the retrained model for use by users before close of business, once it is ready.

Now, consider the case in which the network or compute fabric is to also (re)train a second AI model, model B, that is smaller than that of the model above in an ad-hoc manner. Previously, the network or compute fabric took 36 hours to train this model and a new set of training data has arrived that is relevant to improve the model. Here, the goal is for this model to be updated with the new data be available in the current week.

Without any optimization, the network or compute fabric will need to either:
a.) Wait until model A is done training before it can run the training task for model B. This means that model B will not be available for use until the following week.
b.) Run the training task for model B before starting the training of model A, which could delay model A from being published at its typical time on Friday.

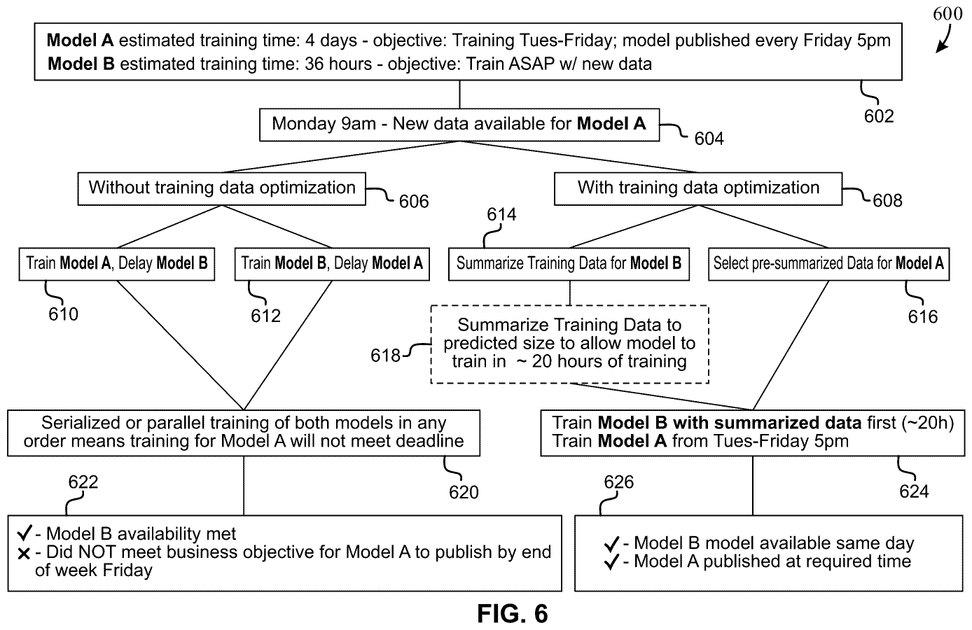

FIG. 6 illustrates an example decision tree 600 for scheduling the training of two AI models, in various implementations. Continuing the example of models A-B, assume that at step 602, scheduling process 249 has access to the constraints for both models. Namely, scheduling process 249 may have access to the training goals for model A and model B. Now, at step 604, scheduling process 249 may obtain an indication that there is new data available at 9:00 AM on Monday.

At step 606, without any optimization, scheduling process 249 may be faced with two options: at step 610, it may opt to train model A and delay model B or, at step 612, it may opt to train model B and delay model A. At step 620, scheduling process 249 may opt for serialized or parallel training of both models. At step 620, one potential consequence of this is that model A will not meet the objective of it being available at the end of the week on Friday, despite model B meeting its availability objective.

According to various implementations, the techniques herein propose reducing the training dataset used to retrain either model A or model B, to satisfy both of the constraints/goals for these models that scheduling process 249 identifies at step 602. For instance, at step 608, scheduling process 249 may opt to either: use summarized training data for model B at step 614 or select pre-summarized data for model A at step 616. As shown, scheduling process 249 may predict at step 618 that using summarized training data for model B, instead of the full set of available training data, that doing so will allow the network or compute fabric to complete retraining of model B in approximately twenty hours of training. In option for this, at step 624, the network or compute fabric can first train model B using the summarized training data in approximately twenty hours, thus allowing the network or compute fabric to train model A between Tuesday through Friday, to make it available for use by end of day on Friday. Consequently, at step 620, model B may be made available within a day, while model A can be made available at its required time.

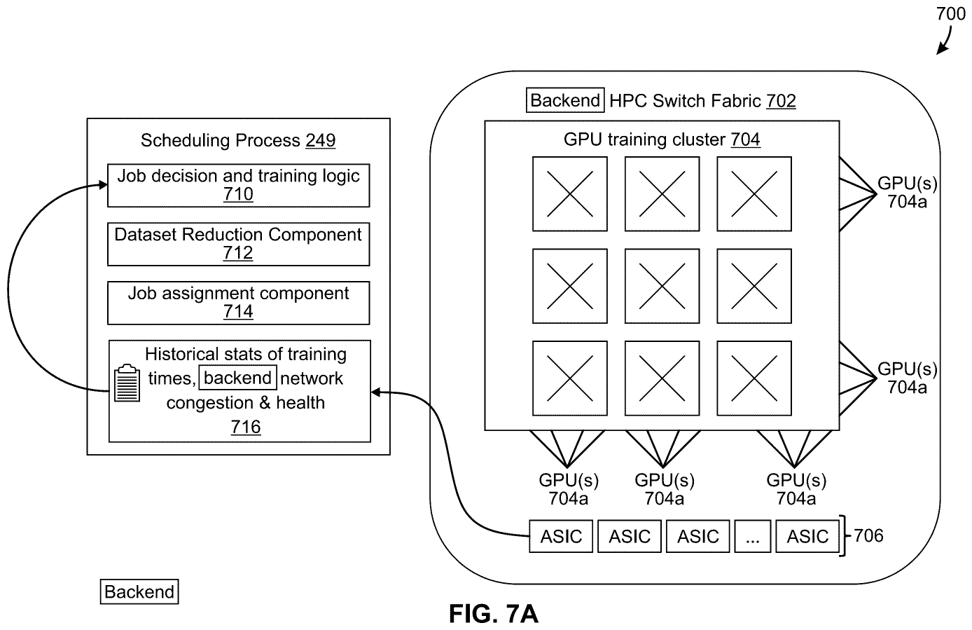

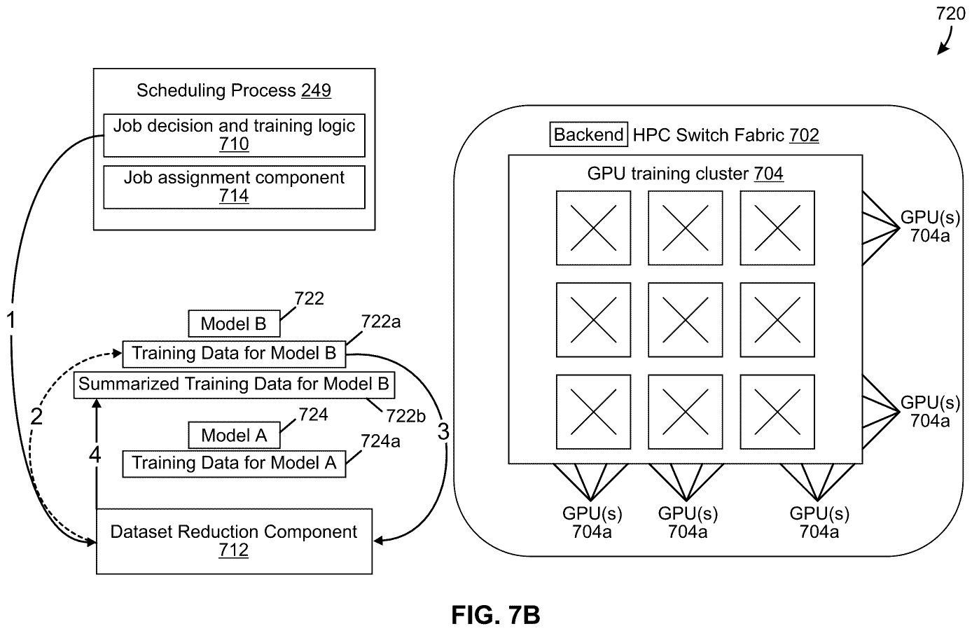

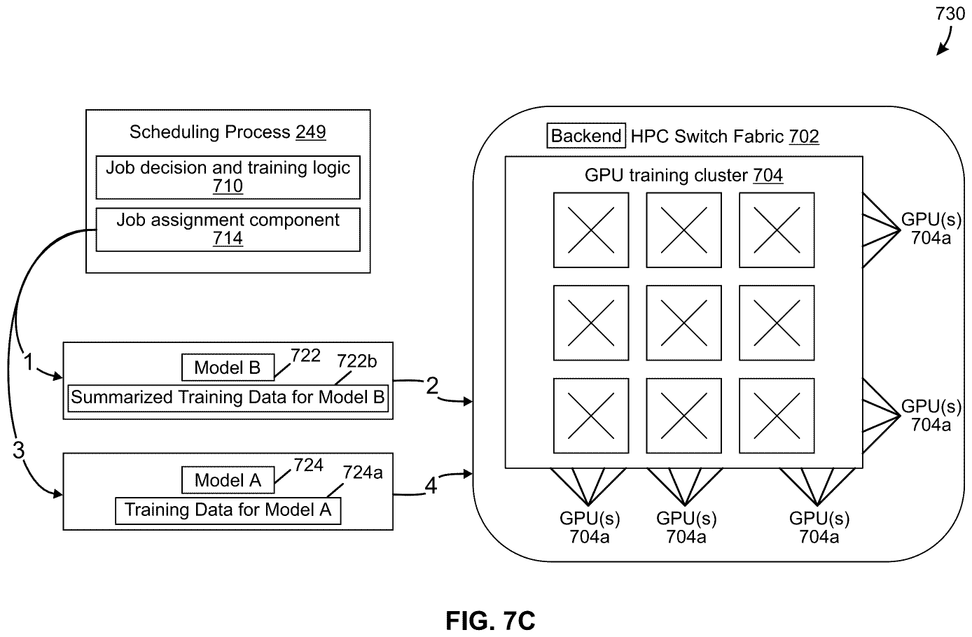

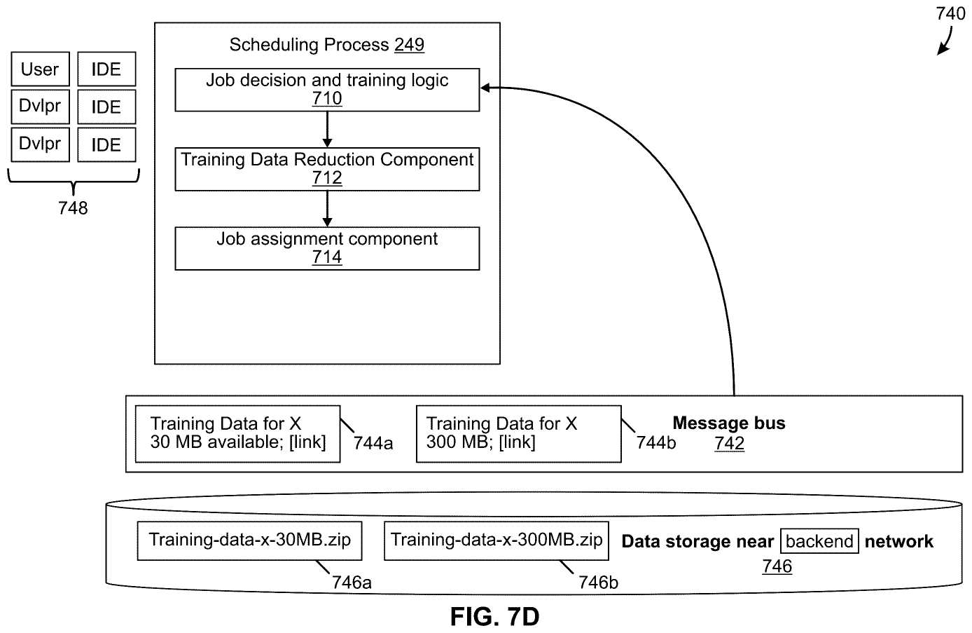

To achieve the above optimization, FIGS. 7A-7D illustrate an example of predictive dataset reduction for scheduling computing tasks in a network or compute fabric, according to various implementations. As shown in FIG. 7A, consider the example 700 in which there is a backend HPC switch fabric 702 that includes a GPU training cluster 704 comprising a plurality of GPUs and ASICs 706. On the frontend may be scheduling process 249 that is responsible for scheduling computing tasks on backend HPC switch fabric 702, such as on GPU training cluster 704 that comprises a plurality of GPUs 704a.

According to various implementations, scheduling process 249 may continuously assess training and other computing tasks, offering an integrated understanding of the demand of the backend network, and the contention on the backend network. To do so, scheduling process 249 may assess information such as model training or other task start/stop times, how frequently the same model is retrained or fine-tuned, the size of the dataset used for model training or completion of the computing task, or the like.

Scheduling process 249 may also review historical statistics from ASICs 706 within backend HPC switch fabric 702 for their network performance metrics, state or health metrics, times of points of contention, or the like. From this information, scheduling process 249 may make a prediction as to how long a given computing task (e.g., training a model using the full dataset available) on GPU training cluster 704 at a point in time.

More specifically, as shown in FIG. 7A, components of backend HPC switch fabric 702, such as ASICs 706, may be configured to report performance metrics 716 to scheduling process 249 for analysis. Performance metrics 716 may include, for instance, historical statics of training times, backend network contention and health information, as well as any other information that scheduling process 249 may use to predict potential contention conditions with respect to backend HPC switch fabric 702.

In various implementations, scheduling process 249 may include logic 710 that is responsible for making decisions regarding computing and training jobs with respect to backend HPC switch fabric 702. Logic 710 may do so based in part on performance metrics 716 collected by scheduling process 249 from backend HPC switch fabric 702. In some implementations, logic 710 may comprise its own AI prediction model that is configured to predict whether a potential computing task for execution in backend HPC switch fabric 702 will lead to a contention condition.

In some implementations, scheduling process 249 may also continuously assess these predictions over time based on performance metrics 716 to improve its model based on these real-world observations. Furthermore, by implanting observability into the backend network (e.g., via ASICs 706), backend HPC switch fabric 702 can measure and signal contention conditions in the backend network to the frontend network (e.g., scheduling process 249 running on the frontend), allowing scheduling process 249 to change the demand on the backend network. During points of contention, backend HPC switch fabric 702 can take advantage of this signaling, allowing it to notify scheduling process 249 of the contention and prompting scheduling process 249 to initiate further scheduling optimizations.

Once logic 710 of scheduling process 249 has predicted and/or observed the capacity of backend HPC switch fabric 702, it may trigger dataset reduction component 712. In various implementations, dataset reduction component 712 may be configured to reduce the full dataset on which a compute task is to operate within backend HPC switch fabric 702. For instance, in the case of a model training task, dataset reduction component 712 may reduce the training dataset in a manner that scheduling process 249 predicts will not lead to contention within backend HPC switch fabric 702 (e.g., based on a finite GPU capacity, a deadline time by which the task is to complete, tec.).

To do so, dataset reduction component 712 may execute in conjunction with the predictive model of logic 710, to determine whether a given dataset reduction is predicted to alleviate the potential contention. For instance, in the case of model training of a first model taking too long and potentially impinging on the training of another model, dataset reduction component 712 may seek to reduce the training dataset for the first model and ask logic 710 for a predicted amount of time or other resources that the model training will take, given the reduced training dataset. Alternatively, dataset reduction component 712 may decide to reduce the dataset of the second model instead of that of the first model, to allow both models to be available as needed.

In various implementations, dataset reduction component 712 may reduce a dataset using any or all of the following approaches:
Summarization of text into a set number of words, tokens, or a file size.
Performing data aggregation of quantitative data, such as by computing an average or standard deviation instead of full sets of raw data for a time period.
Down sampling of the data in the full dataset such as image data or audio data. For instance, dataset reduction component 712 could reduce the resolution or color depth of images, increase the codec compression of an audio file, etc.
Pruning (or dropping) of data from the full dataset. In one implementation, logic 710 may do so by randomly selecting data from the full dataset for pruning within any known stratified groups to prevent the creation of bias, or prune data between a specified period of time. For important information that should not be pruned, logic 710 may ensure that this information persists in the reduced dataset (e.g., a set of critical question and answer data that should not be dropped from the data set, etc.), by tagging this data to ensure its inclusion in the reduced dataset.
Changing ratio of training data vs. testing/validation data from the full dataset, so that more data is used to test/infer than to train the model. This allows for faster model training and then the testing can be performed during gaps in demand where the inference is being processed (as inference clusters may not be shared with the training cluster, and inference demand is more bursty than training demand).

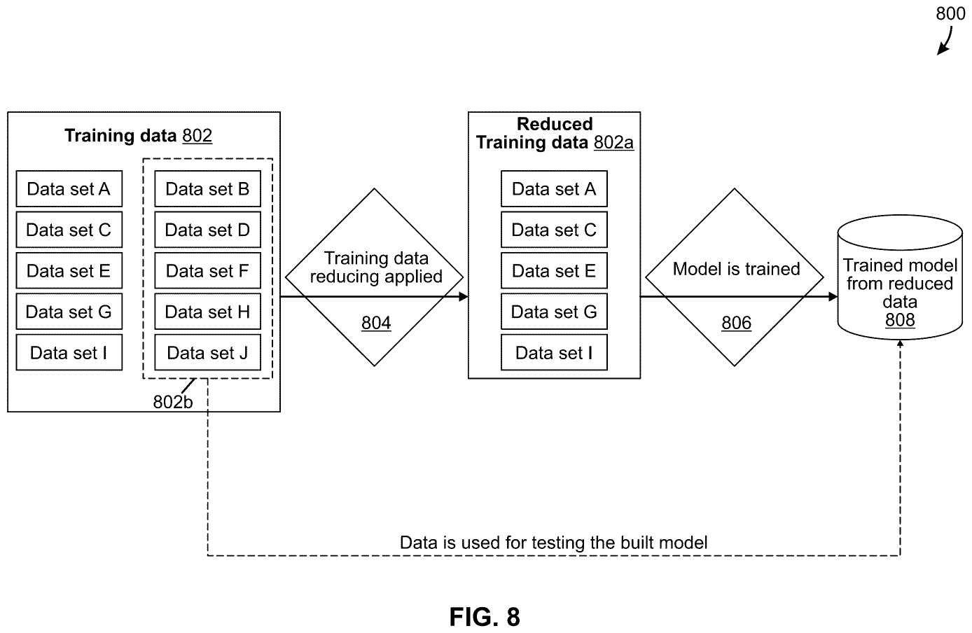

In some implementations, dataset reduction component 712 may also impose one or more constraints when forming the reduced dataset and/or employ multiple data reduction techniques, such as in the case of multimodal data types. For instance, in one implementation, a constraint may be for dataset reduction component 712 to prioritize certain types of multimodal data over others in the full dataset (e.g., video over text or audio, etc.). Another potential constraint may be for dataset reduction component 712 to remove essential data for the model to have relevant intelligence, resulting in the model's inferencing to return inaccurate results, or results that are not consistent with the original data set. Controlling this risk is described in FIG. 8, and also can be reinforced from human review.

As would be appreciated, reducing the full dataset for a computing task, such as model training, is also likely to reduce the accuracy of the final results. Indeed, the more robust the training dataset, the more capable the resulting AI model. Thus, by dataset reduction component 712 reducing the training dataset for a model, the accuracy of the resulting model may also be reduced. However, this may still be acceptable given the requirements for the task. For instance, it may be preferable to make an AI model available as soon as possible, even with reduced accuracy, than to wait to deploy the AI model for use by users. In one implementation, dataset reduction component 712 may also take into account a predicted loss in accuracy, when reducing the full dataset (e.g., it may be acceptable to produce a model with accuracy above a predefined threshold, if it reduces the training time enough to avoid contention with one or more other computing tasks).

Continuing the example described previously with respect to FIG. 6, FIG. 7B illustrates an example 720 of scheduling process 249 deciding to reduce the training dataset for model B mentioned previously. As shown, logic 710 may first predict that scheduling the training of model 722 in backend HPC switch fabric 702 immediately (e.g., starting on Monday at 9:00 AM) will lead to contention with the scheduled training of model 724 (model A) (e.g., starting on Tuesday and running through Friday). In such a case, logic 710 may activate dataset reduction component 712 to determine an optimized dataset to satisfy the requirements for both training tasks. In doing so, dataset reduction component 712 may assess the full training dataset 722a available for model B.

In turn, dataset reduction component 712 may determine that reducing full training dataset 722a into summarized training dataset 722b for model B will reduce the expected time to train model B such that the task would be expected to complete prior to the start time on Tuesday to train model A using its own training dataset 724a.

Referring again to FIG. 7A and shown in greater detail in example 730 in FIG. 7C, scheduling process 249 may also include job assignment component 714 whose role it is to assign computing tasks/jobs to backend HPC switch fabric 702. For instance, in FIG. 7C, job assignment component 714 may assign the task of training the model 722 using summarized training dataset 722b to GPU training cluster 704. Once that task completes, job assignment component 714 may then assign the task of training model A with its own training dataset 724a to GPU training cluster 704.

By training with the reduced data set, it offers the ability for the controller performing scheduling and optimization to reduce training times during points of contention, yet still be able to process and publish models for use. There is a balancing act that the model ideally does need to get priority to be trained with its full data set at some point and to not starve the model of being trained, so weights are applied to the model's training request to influence that it does get fair priority for a full data set training routing in a timely fashion when critical job processing has reduced and there is some processing capacity for reservation.

Another benefit of this approach is some of this processing to reduce the dataset can be done quick (pruning) or by non-GPU processors (data aggregation on a CPU), allowing for staging of reduced training data in advance of when the model training is requested, so it is available for use by the time the reduced data set is needed for quick training. This reduced training data set could be pre-fetched and cached in fast access locations close to the backend network and on fast storage mediums. The data reduced ahead of time could also be done in different size form factors to provide a selection of different sizes of data set, based on the time allowed and/or network constraints as the time it is needed.

FIG. 7D illustrates an example 740 of scheduling process 249 interacting with a message bus 742, in various implementations. In some implementations, scheduling process 249 may publish messages to message bus 742 indicative of the datasets formed by dataset reduction component 712 and/or the full datasets, that are available to entities 748. For instance, entities 748 may comprise developers or other users that operate within an integrated development environment (IDE).

By way of example, a first message 744a on message bus 742 may indicate that a training dataset 746a is stored in data storage 746 near the backend network, a second message 744b on message bus 742 may indicate that training dataset 746b is stored in data storage 746 near the backend network, etc. Doing so allows for entities 748 to use such datasets again in the future for their own purposes. This facilitates other models being rapidly trained in future instances to avoid contention.

FIG. 8 illustrates an example 800 of performing model validation after training an AI model, in accordance with the teachings herein. Once a model is trained, testing can be performed to grade the trained model, as there is a likely chance that the model trained with the reduced training set will perform less optimally than with the full training set.

Accordingly, as shown, the backend network can perform testing of the trained model using the data that was suppressed/dropped from inclusion in the training data before model training. This technique can be used to validate whether the suppressed data has potentially influenced the model negatively. This also allows administrators to set a threshold at which they will not allow a model to be released for use if it fails testing of a certain % from the test data derived from the original set of full training data.

For instance, consider the case of a full dataset of training data 802 that is available for training a model. However, scheduling process 249 may opt not to use the entirety of training data 802 due to predicted contention in the network or compute fabric. Thus, as shown, scheduling process 249 may split training data 802 by applying dataset reduction component 712 at step 804 into two sets: reduced training data 802a and excluded data 802b. In turn, scheduling process 249 may use job assignment component 714 to schedule the training of the model using reduced training data 802a at step 806, resulting in trained model 808.

In various implementations, the system may then use data 802b to validate/test the trained model 808. In one implementation, scheduling process 249 may also add watermark patterns into reduced training data 802a for purposes of validating trained model 808. If trained model 808 does not exhibit performance above at least a predefined threshold, the system may determine that trained model 808 should not be made available for use. In such a case, scheduling process 249 may also use this as feedback to further refine its own prediction model. Indeed, if reduced training data 802a led to trained model 808 exhibiting unacceptable results, this may indicate that too much of training data 802 was excluded from being used to train trained model 808.

Said differently, the techniques herein may operate in multiple stages, to optimize the computational tasks sent to a network or compute fabric for completion, while avoiding contention in the network or compute fabric. To do so, scheduling process 249 may operate in stages as follows:

### Stage 1: Constraint Identification

In this stage, scheduling process 249 identifies constraints that it may use in the subsequent stage(s) for purposes of reducing or prioritizing data for use to complete a computing task. For instance, scheduling process 249 may reduce and/or prioritize data before pre-training, adjusting for constraints like model size, network bandwidth, and training duration. This stage is distinct from pre-training itself, as it prepares a minimized, high-impact dataset based on constraints to reduce overhead while maintaining relevance.

Various performance metrics from the cluster may indicate potential oversubscription of the cluster for model training or other computing tasks. These may be attributes such as, but not limited to, any or all of the following: the size or quality of training data or other dataset, target model size, network performance predictions, and modality of the data (e.g., raw text, audio, QA-paired data with human input).

Some practical constraint examples may be:

### Constraint Situation #1—Constrained by Time

An ample amount of time for data preparation is given before the scheduling of a subsequent training run of twelve hours. The window for training is constrained to twelve hours from the initially planned twenty-four hours due to contention for resources due to other job priorities deemed more important to the business. This means that not all data can be used and those the data must be reduced to match a twelve-hour training run.

### Constraint Situation #2—Constrained by Training Cluster Capacity

An ample amount of time for data preparation is given before the scheduling of a subsequent training run of sixteen hours. The window for training is acceptable. However, due to other higher priority jobs, this training run has been scheduled to run on a medium size cluster versus a large cluster. A medium cluster has fewer GPUs and a smaller capacity network or compute fabric. The result is that what was initially planned as sixteen hours of training data on a large cluster, must be reduced a smaller set of training data relative to the medium size cluster which is 0.7 the size. The result is that 100 GB of training data was planned for the large cluster, must now by reduced down to 70 GB to match a sixteen-hour training run on a medium size cluster.

### Constraint Situation #3—Constrained by Just in Time Request for Training

A request has come in to train a model as soon as possible and finish in less than twenty-four hours. However, the dataset in question in its current form is estimated to take forty-eight or more hours of training time. As a result, data must be reduced ‘on the fly’ to match not only the twenty-four-hour training time, but also to account for the overhead in computing the time to reduce the data. For example, an estimated two hours may be needed process and reduced the data, meaning that the data may be reduced according to an allotted training run of twenty-two hours.

### Constraint Situation #4—Constrained by Fabric Performance

An ample amount of time for data preparation is given before the scheduling of a subsequent training run of twenty hours. The window for training is acceptable. However, current operational issues in the network fabric (such as temporarily down interfaces) result in observed backend network or compute fabric contention, latency, and on average a higher Job Completion Time (JCT) in the previous twenty-four hours of training runs means that training is happening slower than expected by 20%. As a result, the 150 GB of training data which was planned for the twenty hours of training must now be reduced down to 120 GB to match the expected network performance reduction.

### Constraint Situation #5—Constrained by Model Size

An ample amount of time for data preparation is given before the scheduling of a subsequent training run of forty-eight hours. The window for training is acceptable. However, the resulting model must itself be constrained to a certain size due to constraints on where it will be run. Therefore, its training data must be reduced and prioritized to meet the constrained model size.

Note that scheduling process 249 may also identify multiple constraints, in some instances. In such cases, scheduling process 249 may weight each constraint against the others to guide how much data reduction is necessary. For instance, if network constraints are dominant, the data reduction might prioritize data that is most relevant to immediate goals or fine-tune only high-priority segments. Scheduling process 249 may then use these constraints as part of stage 1 above.

### Stage 2: Smart Training Data Reduction Before Training

This stage builds upon the constraint approach from stage 1 above and introduces further data reduction mechanisms. These mechanisms include specific reduction techniques tailored to the data modality, enhancing speed with training. Additionally, it identifies priority data that must be maintained throughout the data reduction process.

As discussed, in this stage, scheduling process 249 then chooses the type(s) of data reduction to apply. This may be based on factors such as:
Training constraints as identified in stage 1. Scheduling process 249 may treat constraints such as network contention differently (e.g. optimize file size) than GPU processing contention, which may instead necessitate model simplification and techniques (optimizing training data simplicity).
Type of training data, as certain modalities of data are reduced with more efficacy with certain approaches (e.g., summarization for text/audio data to remove redundant sentences or mean/median/deviation for quantitative data.)
Classification/prioritization of any data that the user may have selected as important data, that should persist (e.g., if the dataset consists of curated Question & Answer (QA) pairs, data could be annotated to allow for the summarization to ensure retention of that data and summarizing or pruning other QA pairs).

### Stage 3: Weights and Techniques for Pre-Training and Fine-Tuning

In various implementations, scheduling process 249 may not use the data reduction techniques stage 2 in isolation. Instead, it may optionally also actively influence how the model is trained (stage 2), creating a self-optimizing training pipeline. More specifically, in stage 3, scheduling process 249 may optionally use the refined dataset from stages 1 and 2, along with the knowledge and understanding of the summarization approaches, to further optimize the model training by influencing more traditional weighting techniques and attributes.

Using metadata from stage 1 (knowledge of constraints such as dataset size, cluster performance) and stage 2 training data reduction insights, scheduling process 249 can use the information to inform how weights are initialized. For instance, if the data reduction flagged high-quality QA pairs as critical, initialization could weight attention layers towards preserving relevance for those pairs. Some examples of how the pre-training data manipulation information can be further fed into model training optimization are outlined in a few non-exhaustive examples:
Learning Rate Adaptation for Reduced Datasets

The degree of data reduction (e.g., data volume, feature distribution) could also guide learning rate adjustments by scheduling process 249. For heavily pruned datasets, learning rates might be reduced early to prevent overfitting. For instance, say stage 1 and stage 2 identifies the data modality as sparse numerical data. In such a case, scheduling process 249 may, at stage 2, adjust the learning rate scheduler to focus on deeper layers for better generalization.
Constraint-informed Batch Size and Gradient Accumulation

Constraints like network or compute fabric contention or model size can influence whether smaller or larger batches are optimal. For smaller data volumes, gradient accumulation can simulate larger batches, balancing stability, and efficiency.
Adaptive Regularization and Early Stopping

Regularization techniques (e.g., L2, dropout) could adapt to the quality of reduced training data. For highly condensed datasets, stronger regularization might prevent overfitting. Early stopping conditions might be adjusted based on training behavior patterns flagged during stages 1 and 2.

To further demonstrate the interplay between constrains and data reduction done in stages 1-2, and the model training itself in stage 3, consider the following scenarios:
Example 1—Time-Constrained Training:
   Stage 1: Time-constraint is recognized/predicted.
   Stage 2: Reduces data to match the training time constraint (e.g., reduces 100 GB to 50 GB).
   Stage 3: Recognizes that a highly reduced dataset requires more aggressive regularization (e.g., dropout layers).
   Result: The reduced data and adjusted weights prevent overfitting while preserving generalization.
Example 2—Network Performance Bottleneck:
   Stage 1: Network performance constraint is recognized/predicted.
   Stage 2: Reduces data volume to 70 GB for a slower back-end network.
   Stage 3: Dynamically adjusts batch sizes to account for data transfer delays, ensuring smooth training progression.
Example 3—Constraints identified for a Multi-Modality Dataset
Stage 1: A constraint (e.g. training time) is recognized/predicted.
Stage 2: Annotates QA pairs for retention, while summarizing raw text/audio data aggressively.
Stage 3: Prioritizes QA-related weights in attention layers and generalization layers for raw data, ensuring balanced learning across modalities.

### Stage 4: Post-training Review and Optimization of Schedule Predictor

In this stage, scheduling process 249 may compare the predictions on training times for full and reduced training data sets to the predictive time that the model actually took to train. Any significant discrepancies between the predicted time and the actual observed time can be used to reinforce the accuracy and confidence of the prediction algorithm used by scheduling process 249 in stage 1 and also adjust the amount of predicted training data to reduce as identified and performed in stage 2.

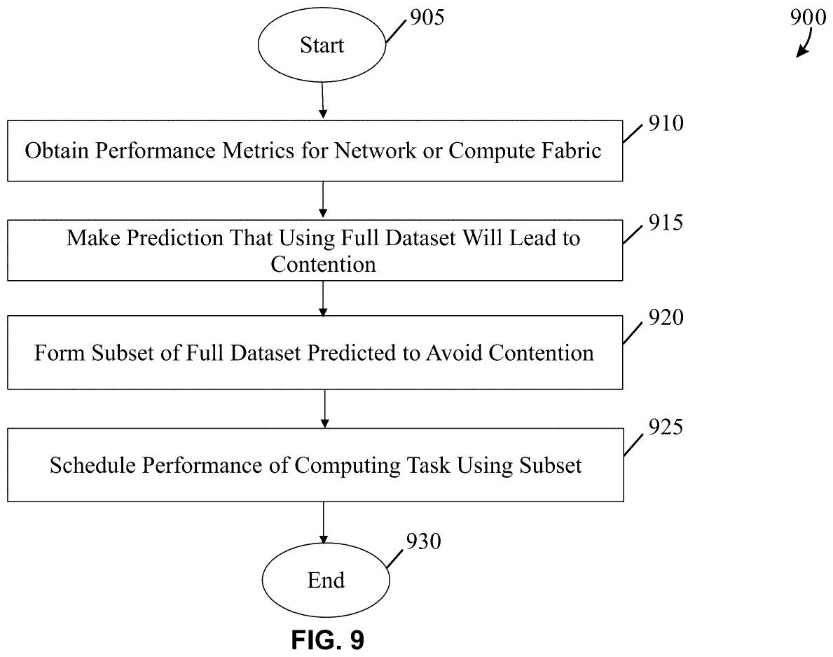

FIG. 9 illustrates an example simplified procedure for predictive dataset reduction for scheduling computing tasks in a network or compute fabric, in accordance with one or more implementations described herein. For example, a non-generic, specifically configured device (e.g., device 200), may perform procedure 900 (e.g., a method) by executing stored instructions (e.g., AI process 248 and/or scheduling process 249). The procedure 900 may start at step 905, and continues to step 910, where, as described in greater detail above, the device (e.g., a controller, server, etc.) may obtain performance metrics for a network or compute fabric. In one implementation, the network or compute fabric comprises at least one backend cluster of graphics processing units (GPUs). In some cases, the performance metrics are indicative of a prior execution time of the second computing task by the network or compute fabric. In further cases, the performance metrics are indicative of at least one of: bandwidth or latency associated with the network or compute fabric.

At step 915, as detailed above, the device may make, based on the performance metrics, a prediction that using a full dataset in network or compute fabric to perform a first computing task would lead to contention in the network or compute fabric with respect to a second computing task. In one implementation, the first computing task comprises training an artificial intelligence model. In various implementations, the prediction indicates that the first computing task will not complete prior to when the second computing task is scheduled to begin.

At step 920, the device may form, based on the prediction, a reduced dataset based on the full dataset that the device predicts will avoid the contention with respect to the second computing task, as described in greater detail above. In various implementations, the reduced dataset comprises a summarization of text in the full dataset or a statistic regarding data in the full dataset. In a further implementation, the device forms the reduced dataset based in part on a parameter that prioritizes inclusion of a certain type of data in the reduced dataset over another type of data in the full dataset. In one implementation, the device forms the reduced dataset in part by inserting watermark patterns into the reduced dataset for purposes of validating the first computing task.

At step 925, as detailed above, the device may schedule performance of the first computing task in the network or compute fabric using the reduced dataset. In some implementations, the network or compute fabric uses the reduced dataset as a training dataset to train an artificial intelligence model and uses data from the full dataset that is not in the reduced dataset to validate the artificial intelligence model after training.

Procedure 900 may then end at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

In other implementations, human reinforcement may also be added, to provide feedback from supervised manual human review when the model provides undesired or inaccurate results. In those scenarios, a negative weight can be applied to the training data reduction logic to reduce the confidence level around being able to reduce/remove that type of data from the data set without materially affecting the training model's responses.

While there have been shown and described illustrative implementations that allow for providing accessibility to visually impaired users of dynamic applications, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device, performance metrics for a network or compute fabric;
making, by the device and based on the performance metrics, a prediction that using a full dataset in network or compute fabric to perform a first computing task would lead to contention in the network or compute fabric with respect to a second computing task;
forming, by the device and based on the prediction, a reduced dataset based on the full dataset that the device predicts will avoid the contention with respect to the second computing task; and
scheduling, by the device, performance of the first computing task in the network or compute fabric using the reduced dataset.

2. The method as in claim 1, wherein the first computing task comprises training an artificial intelligence model.

3. The method as in claim 2, wherein the network or compute fabric uses the reduced dataset as a training dataset to train the artificial intelligence model, and wherein the network or compute fabric uses data from the full dataset that is not in the reduced dataset to validate the artificial intelligence model after training.

4. The method as in claim 1, wherein the network or compute fabric comprises at least one backend cluster of graphics processing units (GPUs).

5. The method as in claim 1, wherein the prediction indicates that the first computing task will not complete prior to when the second computing task is scheduled to begin.

6. The method as in claim 1, wherein the performance metrics are indicative of a prior execution time of the second computing task by the network or compute fabric.

7. The method as in claim 1, wherein the reduced dataset comprises a summarization of text in the full dataset or a statistic regarding data in the full dataset.

8. The method as in claim 1, wherein the device forms the reduced dataset based in part on a parameter that prioritizes inclusion of a certain type of data in the reduced dataset over another type of data in the full dataset.

9. The method as in claim 1, wherein the device forms the reduced dataset in part by inserting watermark patterns into the reduced dataset for purposes of validating the first computing task.

10. The method as in claim 1, wherein the performance metrics are indicative of at least one of: bandwidth or latency associated with the network or compute fabric.

11. An apparatus, comprising:
one or more network interfaces;
a processor coupled to the one or more network interfaces and configured to execute one or more processes; and
a memory configured to store a process that is executable by the processor, the process when executed configured to:
obtain performance metrics for a network or compute fabric;
make, based on the performance metrics, a prediction that using a full dataset in network or compute fabric to perform a first computing task would lead to contention in the network or compute fabric with respect to a second computing task;
form, based on the prediction, a reduced dataset based on the full dataset that the apparatus predicts will avoid the contention with respect to the second computing task; and
schedule performance of the first computing task in the network or compute fabric using the reduced dataset.

12. The apparatus as in claim 11, wherein the first computing task comprises training an artificial intelligence model.

13. The apparatus as in claim 12, wherein the network or compute fabric uses the reduced dataset as a training dataset to train the artificial intelligence model, and wherein the network or compute fabric uses data from the full dataset that is not in the reduced dataset to validate the artificial intelligence model after training.

14. The apparatus as in claim 11, wherein the network or compute fabric comprises at least one backend cluster of graphics processing units (GPUs).

15. The apparatus as in claim 11, wherein the prediction indicates that the first computing task will not complete prior to when the second computing task is scheduled to begin.

16. The apparatus as in claim 11, wherein the performance metrics are indicative of a prior execution time of the second computing task by the network or compute fabric.

17. The apparatus as in claim 11, wherein the reduced dataset comprises a summarization of text in the full dataset or a statistic regarding data in the full dataset.

18. The apparatus as in claim 11, wherein the apparatus forms the reduced dataset based in part on a parameter that prioritizes inclusion of a certain type of data in the reduced dataset over another type of data in the full dataset.

19. The apparatus as in claim 11, wherein the apparatus forms the reduced dataset in part by inserting watermark patterns into the reduced dataset for purposes of validating the first computing task.

20. A tangible, non-transitory, computer-readable medium storing program instructions that cause a device to execute a process comprising:
obtaining, by the device, performance metrics for a network or compute fabric;
making, by the device and based on the performance metrics, a prediction that using a full dataset in network or compute fabric to perform a first computing task would lead to contention in the network or compute fabric with respect to a second computing task;
forming, by the device and based on the prediction, a reduced dataset based on the full dataset that the device predicts will avoid the contention with respect to the second computing task; and
scheduling, by the device, performance of the first computing task in the network or compute fabric using the reduced dataset.
